(19) United States
(12) Patent Application Publication
(10) Pub. No.: US 2023/0327942 A1
(43) Pub. Date: Oct. 12, 2023

(54) DATA DETECTION METHOD AND APPARATUS, ELECTRONIC DEVICE, COMPUTER STORAGE MEDIUM, AND COMPUTER PROGRAM PRODUCT

(71) Applicant: Tencent Technology (Shenzhen) Company Limited, Shenzhen (CN)

(72) Inventor: Menghao ZHAO, Shenzhen (CN)

(21) Appl. No.: 18/207,020

(22) Filed: Jun. 7, 2023

Related U.S. Application Data
(63) Continuation of application No. PCT/CN2022/126378, filed on Oct. 20, 2022.

(30) Foreign Application Priority Data
Nov. 29, 2021 (CN) 202111436035.6

(51) Int. Cl. H04L 41/22; H04L 41/0654

(52) U.S. Cl. CPC H04L 41/0654; H04L 41/22

(57) ABSTRACT

Provided are a data detection method performed by an electronic device. The method includes: obtaining, in response to a detection trigger instruction, processing information of a plurality of processing nodes in a data processing link for a target content, and an event trigger condition, determining circulation information of the target content in the plurality of processing nodes using the respective processing information of the plurality of processing nodes; determining, when at least one of the processing information and the circulation information hits the event trigger condition, occurrence of a detection event corresponding to the event trigger condition in the data processing link; collecting data for the detection event to obtain detection data corresponding to the detection event; and displaying the detection event in a detection event region of a detection interface, the detection data in a data display region of the detection interface.

### CROSS-REFERENCE TO RELATED APPLICATIONS

This application is a continuation application of PCT Patent Application No. PCT/CN2022/126378, entitled “DATA DETECTION METHOD AND APPARATUS, ELECTRONIC DEVICE, COMPUTER STORAGE MEDIUM, AND COMPUTER PROGRAM PRODUCT” filed on Oct. 20, 2022, which based on and claims priority to Chinese Patent Application No. 202111436035.6, entitled “DATA DETECTION METHOD AND APPARATUS, ELECTRONIC DEVICE, COMPUTER STORAGE MEDIUM, AND COMPUTER PROGRAM PRODUCT” filed on Nov. 29, 2021, and claims priority to this application, all of which is incorporated by reference in its entirety.

### FIELD OF THE TECHNOLOGY

This application relates to big data technology, and in particular, to a data detection method and apparatus, an electronic device, a computer storage medium, and a computer program product.

### BACKGROUND OF THE DISCLOSURE

In the era of big data, content centers will add tens of millions of content per day, and processing links involved are extremely complex. If a certain processing node of a data processing link is abnormal, for example, the load of the processing node is too high, the time consumption of the data processing link is increased, or delivery contents are sharply reduced due to the failure of a review standard, thereby greatly affecting a content center.

In order to find anomalies as early as possible and to locate the cause, it is necessary to perform data detection on processing of the data processing link to timely expose the anomalies through the detected data. In the related art, data detection is mostly performed on a content processing situation inside processing nodes, whereby the detection range of data detection is small, and an anomaly detection rate of the data processing link is finally affected.

### SUMMARY

Embodiments of this application provide a data detection method and apparatus, an electronic device, a computer-readable storage medium, and a computer program product, which can expand a detection range of data detection and improve an anomaly detection rate of a data processing link.

Technical solutions in this embodiment of this application are implemented as follows.

This embodiment of this application provides a data detection method. The method is performed by an electronic device, and includes:
obtaining, in response to a detection trigger instruction, processing information of a plurality of processing nodes in a data processing link for a target content and a corresponding event trigger condition;
determining circulation information of the target content in the plurality of processing nodes using the respective processing information of the plurality of processing nodes;
determining, when at least one of the processing information and the circulation information hits the event trigger condition, occurrence of a detection event corresponding to the event trigger condition in the data processing link;
collecting data for the detection event to obtain detection data corresponding to the detection event; and
displaying the detection event in a detection event region of a detection interface, the detection data in a data display region of the detection interface.

This embodiment of this application provides an electronic device for data detection, including:
a memory, configured to store executable instructions; and
a processor, configured to implement, when executing the executable instructions stored in the memory, the data detection method provided in this embodiment of this application.

This embodiment of this application provides a non-transitory computer-readable storage medium storing executable instructions that, when executed by a processor of an electronic device, causes the electronic device to perform the data detection method provided in this embodiment of this application.

This embodiment of this application has the following beneficial effects. By using processing information of different processing nodes for a target content, a processing situation of the processing nodes for the target content can be specified. By using circulation information determined according to different processing information, a circulation situation of the target content between different processing nodes can be specified. By determining whether any one of the processing information and the circulation information hits an event trigger condition, whether events occurring when processing nodes perform respective service processing in a data processing link or events occurring when content is in a circulation process can be captured and data collection can be performed to obtain corresponding detection data, thereby expanding a detection range of data detection and finally improving the anomaly detection rate of the data processing link.

### BRIEF DESCRIPTION OF THE DRAWINGS

FIG. 1 is a schematic architectural diagram of a data detection system according to an embodiment of this application.

FIG. 2 is a schematic structural diagram of a server in FIG. 1 according to an embodiment of this application.

FIG. 3 is a schematic flowchart of a data detection method according to an embodiment of this application.

FIG. 4A is a schematic diagram of a detection event and detection data according to an embodiment of this application.

FIG. 4B is another schematic diagram of a detection event and detection data according to an embodiment of this application.

FIG. 5 is another schematic flowchart of a data detection method according to an embodiment of this application.

FIG. 6A is a schematic diagram of an abnormal event according to an embodiment of this application.

FIG. 6B is another schematic diagram of an abnormal event according to an embodiment of this application.

FIG. 6C is yet another schematic diagram of an abnormal event according to an embodiment of this application.

FIG. 7 is a schematic diagram of abnormal sub-circulation information according to an embodiment of this application.

FIG. 8 is a schematic diagram of determining a to-be-configured service according to an embodiment of this application.

FIG. 9 is a schematic diagram of a condition editing interface according to an embodiment of this application.

FIG. 10 is a schematic diagram of a service configuration region according to an embodiment of this application.

FIG. 11 is a schematic diagram of a service creation interface according to an embodiment of this application.

FIG. 12 is an information query interface according to an embodiment of this application.

FIG. 13 is a schematic diagram of a processing link according to an embodiment of this application.

FIG. 14 is a schematic diagram of reporting a detection situation on an inspection platform according to an embodiment of this application.

FIG. 15 is a schematic flowchart of displaying a life cycle on a visualization platform according to an embodiment of this application.

FIG. 16 is a schematic diagram of generating a content experience according to an embodiment of this application.

### DESCRIPTION OF EMBODIMENTS

To make the objectives, technical solutions, and advantages of this application clearer, the following describes this application in further detail with reference to the accompanying drawings. The described embodiments are not to be considered as a limitation to this application. All other embodiments obtained by a person of ordinary skill in the art without creative efforts shall fall within the protection scope of this application.

In the following description, the term “some embodiments” describes subsets of all possible embodiments, but it is to be understood that “some embodiments” may be the same subset or different subsets of all the possible embodiments, and can be combined with each other without conflict.

Unless otherwise defined, meanings of all technical and scientific terms used in this specification are the same as those usually understood by a person skilled in the art to which this application belongs. The terms used in this specification are for the purpose of describing the embodiments of this application only and are not intended to be limiting of this application.

Before the embodiments of this application are further described in detail, a description is made on nouns and terms in the embodiments of this application, and the nouns and terms in the embodiments of this application are applicable to the following explanations.

1) Big data refers to a data set that cannot be captured, managed and processed by conventional software tools within a certain time range, and is a massive, high-growth and diversified information asset that requires a new processing mode to have stronger decision-making power, insight discovery power and process optimization capability. With the advent of cloud era, big data has attracted more and more attention. Big data requires a special technology to effectively process a large number of data within a tolerable time. Technologies for big data include massively parallel processing databases, data miners, distributed file systems, distributed databases, cloud computing platforms, the Internet, and scalable storage systems.

2) A target content refers to content introduced on line, for example, image-text or video introduced from a news APP or a browser. These contents need to be reviewed and processed before being distributed to common client terminals. In a big data scene, about 30 million contents to be processed are added every day.

3) A data processing link refers to an overall flow of a content (for example, video) including warehousing, data processing, capability processing, review, and distribution to client terminal or off-shelf.

4) A content identifier is an identifier for distinguishing between ids and names of different contents. The identifiers of different contents are globally unique and can be used for content retrieval.

5) An abnormal event refers to an event in which an abnormality or problem occurs in some links of a data processing link and the abnormal event may disable the content to be continuously processed, that is, the data processing link for the content is interrupted. For example, under normal circumstances, the content will be processed and reviewed within a certain time after entering the data processing link, and it is determined whether the content may be delivered, recommended, and the like. If the content has not been processed and reviewed beyond a certain time, or the ratio of delivery to non-delivery and recommendation to non-recommendation after the completion of processing has changed greatly, it is indicated that an abnormal event has occurred in the data processing link. At this moment, processing nodes with the abnormal event occurring in the data processing link need to be checked.

6) Response represents a condition or state upon which performed operations depend, where one or more of the performed operations may be real-time or may have a set delay when the dependent condition or state is satisfied. Without being specifically stated, there is no limitation to the order in which the operations are performed.

In the era of big data, content centers will add tens of millions of content per day, and processing links involved are extremely complex. If a certain processing node of a data processing link is abnormal, for example, the load of the processing node is too high, the time consumption of the data processing link is increased, or delivery contents are sharply reduced due to the failure of a review standard, thereby greatly affecting a content center.

In order to find anomalies as early as possible and to locate the cause, it is necessary to perform data detection on processing of the data processing link to timely expose the anomalies through the detected data. Also, specific data analysis can also be performed using the detected data. For example, when a review algorithm policy or a review criterion is adjusted, it may be determined whether the algorithm policy or the review criterion is valid by a delivery rate, an enabling rate, and the like of the detected data analysis content. In other words, data detection plays an important role in the detection of abnormal situations in the data processing link and the analysis of algorithm effects.

In the relevant art, processing nodes on a data processing link detect respective processing services. That is to say, when an event of interest occurs within a service corresponding to the processing node, data detection is performed for the event, and then each processing node respectively reports the detected data and displays the data in detection views corresponding to the processing nodes. It can be seen that, in the related art, data detection can only be limited to the processing situation of the content inside the processing nodes, and the event of the content in the circulation process between different processing nodes cannot be detected, whereby the detection range of data detection is small, the anomaly occurring in the circulation process of the content cannot be detected, and the anomaly detection rate of the data processing link is finally affected. Furthermore, the data detected by the processing nodes is displayed separately, and a display view needs to be generated separately for each processing node, thereby requiring additional occupation of computing resources.

Further, on the basis of the related art, if it is desired to detect the circulation situation of the content, a detection logic which does not belong to a processing process needs to be additionally added in the data processing link, thereby making the logic of the data processing link more complicated, and finally making a storage space required for an implementation code of the data processing link increased.

Then, in the related art, the processing nodes merely report the detected data and displays the data in a corresponding detection view without generating corresponding life cycle information for the whole processing process in the data processing link, whereby when querying a processing flow of a certain content, the processing nodes need to be located together, thereby making it difficult to query the flow.

Based on this, this embodiment of this application provides a data detection method and apparatus, an electronic device, a computer-readable storage medium, and a computer program product, which can expand a detection range of data detection and improve an anomaly detection rate of a data processing link. An exemplary application of the electronic device for data detection provided by this embodiment of this application is described below. The electronic device provided by this embodiment of this application may be implemented as various types of terminals, such as a laptop computer, a tablet computer, a desktop computer, a set-top box, and a mobile device, and may also be implemented as a server (the server may be configured with a front end for displaying information generated by the server). An exemplary application when the electronic device is implemented as a server will be described below.

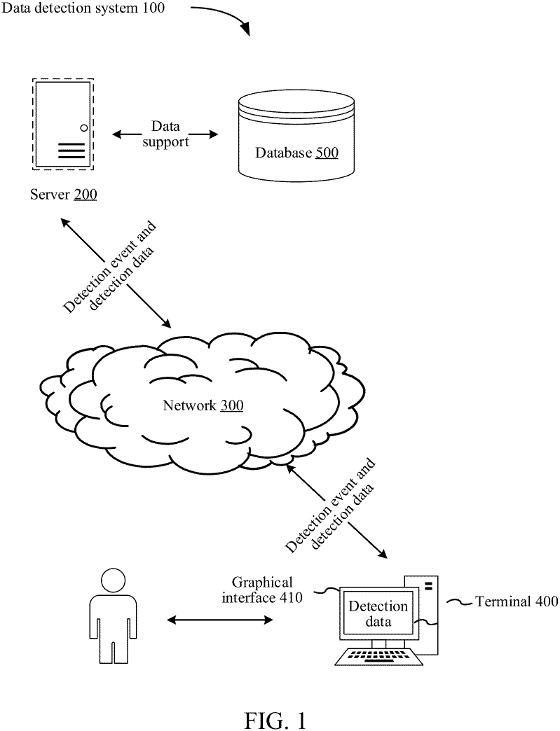

Reference is made to FIG. 1. FIG. 1 is a schematic architectural diagram of a data detection system according to an embodiment of this application. In order to support a data detection application, in a data detection system 100, a terminal 400 (referred to as a front end of a server 200) is connected to a server 200 (referred to as an electronic device) via a network 300. The network 300 may be a wide area network or a local area network, or a combination of both. A database 500 is also configured in the data detection system 100 to provide data support to the server 200. The database 500 may be independent of the server 200 or may be integrated in the server 200. FIG. 1 shows a case where the database 500 is independent of the server 200.

The server 200 is configured to: obtain, in response to a detection trigger instruction (timing trigger), processing information of a plurality of processing nodes in a data processing link for a target content, and an event trigger condition, the plurality of processing nodes including at least two of the following nodes: a warehousing processing node, a function processing node, and a review processing node; determine circulation information of the target content in the plurality of processing nodes using the respective processing information of the plurality of processing nodes; determine, when at least one of the processing information and the circulation information hits the event trigger condition, occurrence of a detection event corresponding to the event trigger condition in the data processing link; collect data for the detection event to obtain detection data corresponding to the detection event; and transmit the detection event and the detection data to the terminal 400 via the network 300, and control the terminal 400 to display the detection event in a detection event region of a detection interface displayed by a graphical interface 410 and to display the detection data in a data display region of the detection interface.

This embodiment of this application may be implemented by cloud. The cloud refers to a hosting technology for unifying a series of resources, such as hardware, software, and networks, and realizing the computation, storage, processing, and sharing of data in a wide area network or a local area network.

The cloud is a general term of a network technology, an information technology, an integration technology, a management platform technology, and an application technology based on cloud computing business model application. The technology may be used as needed and flexibly and conveniently by composing a resource pool. The cloud computing technology becomes an important support. A background service of a technical network system requires a large amount of computing and storage resources, and needs to be realized by cloud computing.

Exemplarily, the server 200 may be an independent physical server, may also be a server cluster or distributed system composed of a plurality of physical servers, and may also be a cloud server providing basic cloud computing services, such as a cloud service, a cloud database, cloud computing, a cloud function, cloud storage, a network service, cloud communication, a middleware service, a domain name service, a security service, a CDN, and a large data and artificial intelligence platform. The terminal 400 may be a smartphone, a tablet computer, a laptop computer, a desktop computer, a smart speaker, a smartwatch, a smart appliance, a vehicle-mounted terminal, or the like, but is not limited thereto. The terminal and the server may be directly or indirectly connected in a wired or wireless communication manner. This embodiment of this application is not limited thereto.

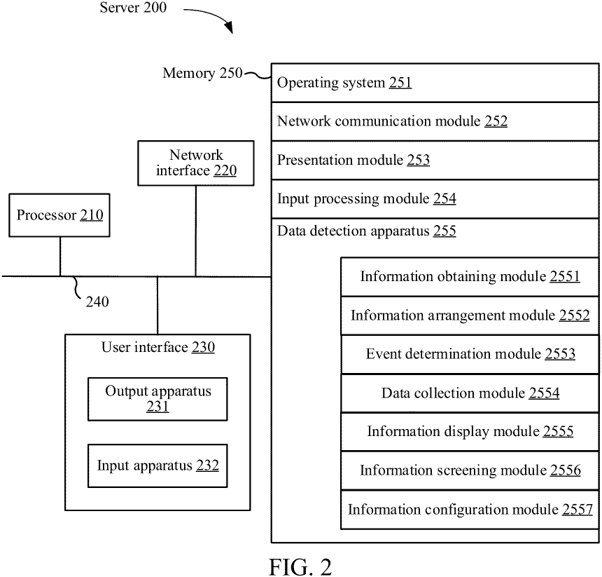

Reference is made to FIG. 2. FIG. 2 is a schematic structural diagram of a server (an implementation of an electronic device) in FIG. 1 according to an embodiment of this application. The server 200 shown in FIG. 2 includes: at least one processor 210, a memory 250, at least one network interface 220, and a user interface 230. Components in the server 200 are coupled together by using a bus system 240. It is to be understood that, the bus system 240 is configured to implement connection and communication between the components. In addition to a data bus, the bus system 240 further includes a power bus, a control bus, and a state signal bus. However, for ease of clear description, all types of buses in FIG. 2 are marked as the bus system 240.

The processor 210 may be an integrated circuit chip having signal processing capabilities, for example, a general processor, a digital signal processor (DSP), another programmable logic device, discrete gate or transistor logic device, or discrete hardware component, or the like. The general processor may be a microprocessor, any conventional processor, or the like.

The user interface 230 includes one or more output apparatuses 231 that enable the presentation of media content, including one or more speakers and/or one or more visual display screens. The user interface 230 further includes one or more input apparatuses 232, including user interface components that facilitate user input, such as a keyboard, a mouse, a microphone, a touch-screen display, a camera, or another input button and control.

The memory 250 may be removable, non-removable, or a combination thereof. Exemplary hardware devices include solid state memories, hard disk drives, optical disk drives, and the like. The memory 250 includes one or more storage devices physically remote from the processor 210.

The memory 250 includes a volatile memory or a non-volatile memory, or may include both a volatile memory and a non-volatile memory. The non-volatile memory may be a read only memory (ROM), and the volatile memory may be a random access memory (RAM). The memory 250 described in this embodiment of this application aims to include any suitable type of memory.

In some embodiments, the memory 250 is capable of storing data to support various operations. Examples of the data include programs, modules, and data structures or subsets or supersets thereof, as exemplified below.

An operating system 251 includes a system program for processing various basic system services and executing hardware-related tasks, such as a framework layer, a core library layer, and a driver layer, for realizing various basic services and processing hardware-based tasks.

A network communication module 252 is configured to reach other computing devices via one or more (wired or wireless) network interfaces 220. The network interface 220 exemplarily includes: Bluetooth, wireless fidelity (Wi-Fi), and universal serial bus (USB), and the like.

A presentation module 253 is configured to enable presentation of information (for example, a user interface for operating peripherals and displaying content and information) via one or more output apparatuses 231 (for example, a display screen, a speaker, or the like) associated with a user interface 230.

An input processing module 254 is configured to detect one or more user inputs or interactions from one or more input apparatuses 232 and translate the detected inputs or interactions.

In some embodiments, the data detection apparatus provided by this embodiment of this application may be implemented in software. FIG. 2 shows a data detection apparatus 255 stored in a memory 250, which may be software in the form of a program and a plug-in. The apparatus includes the following software modules: an information obtaining module 2551, an information arrangement module 2552, an event determination module 2553, a data collection module 2554, an information display module 2555, an information screening module 2556, and an information configuration module 2557. The modules are logical, and thus may be combined in any combination or further split according to the functions realized. The functions of the various modules will be described below.

In other embodiments, the data detection apparatus provided by this embodiment of this application may be implemented in hardware. As an example, the data detection apparatus provided by this embodiment of this application may be a processor in the form of a hardware decoding processor which is programmed to perform the data detection method provided by this embodiment of this application. For example, the processor in the form of a hardware decoding processor may use one or more application specific integrated circuits (ASIC), a DSP, a programmable logic device (PLD), a complex programmable logic device (CPLD), a field-programmable gate array (FPGA), or other electronic components.

In some embodiments, the terminal or the server (both being possible implementations of an electronic device) may implement the data detection method provided by this embodiment of this application by running a computer program. For example, the computer program may be a native program or a software module in an operating system. The computer program may also be a native application (APP), namely a program executable after being installed in the operating system, such as a data detection APP. The computer program may also be a mini program, namely a program executable after being downloaded in a browser environment. The computer program may also be a mini program embeddable into any APP. In general, the computer program may be any form of application, module, or plug-in.

This embodiment of this application may be applied to various scenes such as cloud technology, artificial intelligence, intelligent traffic, and vehicles. The data detection method provided by this embodiment of this application will be described below in connection with exemplary applications and implementations of the electronic device provided by this embodiment of this application.

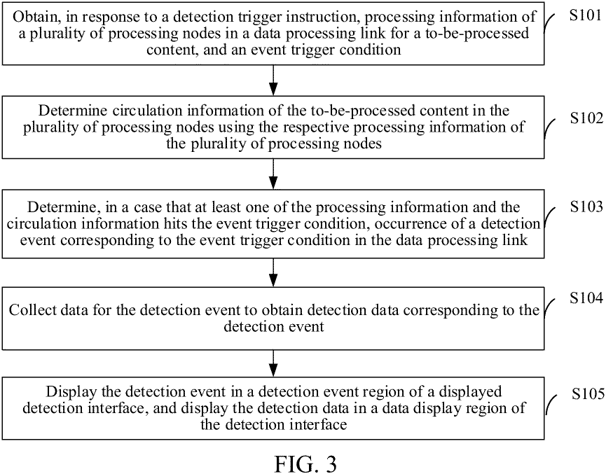

Reference is made to FIG. 3. FIG. 3 is a schematic flowchart of a data detection method according to an embodiment of this application. The method is described with steps shown in FIG. 3.

S101: Obtain, in response to a detection trigger instruction, processing information of a plurality of processing nodes in a data processing link for a target content, and an event trigger condition.

This embodiment of this application is realized in a scene of performing data detection on an event to be detected in a data processing link, for example, performing data detection on the quantity of contents reviewed in the data processing link, or performing data detection on a processing flow of content in the data processing link, or the like. In this embodiment of this application, the data detection process is triggered by the detection trigger instruction. The data processing link has a plurality of processing nodes, for example, function processing nodes, review processing nodes, warehousing processing nodes, and the like. Each processing node performs one or more service processing (for example, video entry, image-text review, and the like) on a target content so as to obtain processing information for one or more service scenes. After detecting the detection trigger instruction, the electronic device obtains processing information generated by each processing node for the target content, so as to specify a processing situation of the processing node for the target content. Also, the electronic device also obtains an event trigger condition of the data processing link. The event trigger condition is a determination basis for determining whether a detection event occurs.

It is to be understood that the detection trigger instruction may be generated periodically by the electronic device. For example, the detection trigger instruction is generated automatically at 12:00 a day, whereby the electronic device starts the data detection flow on time at 12:00 a day. The detection trigger instruction may also be generated in response to an operation by an operator. For example, upon detecting an operation representing initiation of data detection, the electronic device may generate the detection trigger instruction to start the data detection flow based on actual needs of the operator.

It is to be noted that the target content may be a single content or may refer to a content set composed of a large amount of contents. This application is not limited thereto. The target content includes, but is not limited to, articles, videos, and images. Different processing nodes may generate different processing information for the target content. The processing information of the target content includes, but is not limited to, generated results of the target content under different service processes (for example, approval or not approval under a review service), processing time consumption, source identifiers allocated for the target content (for indicating a platform providing the target content), function fields generated for the target content (for briefly describing details of the target content), and the like.

The event trigger condition may refer to a trigger condition of an abnormal situation during service processing, for example, a trigger condition of a picture link conversion failure phenomenon in an image-text scene, and may also refer to a trigger condition of an abnormal situation of the whole data processing link, for example, a trigger condition for a content delivery timeout phenomenon, or a trigger condition for a too long content processing time, and the like. This embodiment of this application is not limited thereto.

It is to be noted that the plurality of processing nodes include at least two of the following nodes: a warehousing processing node, a function processing node, and a review processing node. The warehousing processing node is used for creating content data in the data processing link for the warehoused target content, generating a unique content identifier, and recording the creation time. The function processing node is used for performing classification, deduplication, account processing, and picture in-chaining on the target content, and generating a corresponding function field. The review processing node includes a machine review processing node, a machine review result node, a manual review scheduling node, and a manual review result node. The machine review processing node is used for generating a machine review result of the target content based on specific contents, such as function fields, and image-text and video of the target content. The machine review result node is used for collecting the machine review result, and transmitting the target content to the manual review scheduling node when the machine review result is failed. The manual review scheduling node is used for allocating the target content to professional reviewers. The manual review result node is used for collecting a manual review result.

S102: Determine circulation information of the target content in the plurality of processing nodes using the respective processing information of the plurality of processing nodes.

After determining the processing information generated by the plurality of processing nodes for the target content, the electronic device arranges the processing information generated by different processing nodes according to a time sequence of the processing information, so as to specify information such as the processing node bypassed by the target content in the data processing link, the precedence order of different processing nodes, and the processing duration of the processing nodes. The foregoing information may all indicate the circulation situation of the target content in the data processing link, namely, the circulation situation of to-be-processed information among the plurality of processing nodes.

In some embodiments, the electronic device may extract time information (which may include a processing start time and a processing end time) from the processing information of the processing nodes, and sort and arrange the processing information corresponding to the processing nodes according to the time information, so as to obtain circulation information. In other embodiments, the electronic device may further extract duration information from the processing information of the processing nodes, generate summary fields for the processing information, and sort the summary fields according to the duration information, to obtain circulation information.

It is to be noted that when the plurality of processing nodes include a warehousing processing node, the processing information obtained by the electronic device includes a content identifier corresponding to the target content. Thus, the electronic device may correspondingly store the circulation information of the target content among the plurality of processing nodes and the content identifier. Thus, when the circulation information is searched subsequently, the content identifier may be directly used for querying, whereby the circulation information can be searched more conveniently and is easier to store (because the storage space required by the target content is generally greater than the storage space required by the content identifier).

S103: Determine, when at least one of the processing information and the circulation information hits the event trigger condition, occurrence of a detection event corresponding to the event trigger condition in the data processing link.

After obtaining the processing information and the circulation information, the electronic device matches the processing information and the circulation information with the event trigger condition, respectively. When there is a condition matching the processing information in the event trigger condition, namely, the processing information hits the event trigger condition, the electronic device determines that a detection event to be detected occurs in the service processing of the processing nodes. When there is a condition matching the circulation information in the event trigger condition, namely, the circulation information hits the event trigger condition, the electronic device determines that a detection event to be detected occurs in the circulation process of the target content in the plurality of processing nodes. When there are both conditions matching the processing information and the circulation information in the event trigger condition, the electronic device determines that a detection event occurs both in the service processing of the processing nodes and in the circulation process of the target content.

That is to say, in this embodiment of this application, determining whether a detection event to be detected occurs is determined by the event trigger condition. In this way, whether a detection event of a service processing flow of a processing node occurs or a detection event of a circulation process of a different processing node occurs, data can be captured and detected as long as the event trigger condition is satisfied.

S104: Collect data for the detection event to obtain detection data corresponding to the detection event.

The electronic device collects data corresponding to the detection event after specifying an event to be detected, for example, counting occurrences of the detection event, counting the processing time consumption of the detection event, and the like, and determines the collected data as the detection data of the detection event.

For example, when the detection event is invoking account registration, the electronic device may collect the total number of account registrations and the time taken for account registrations, so as to obtain the detection data. In some embodiments, the detection data may be collected by event tracking. For example, the electronic device may perform event tracking based on policies such as the amount of requests, the amount of execution successes, the amount of execution failures, the time consumption of phases, the distribution of sources, account level, and the legitimacy of content, and based on a combination of the policies. This application is not limited thereto.

S105: Display the detection event in a detection event region of a displayed detection interface, and display the detection data in a data display region of the detection interface.

In order to enable the operator to understand the specific situation of the detection event, in this embodiment of this application, the electronic device is capable of simultaneously displaying the detection event and the detection data on the detection interface being displayed after the detection data of the detection event is obtained.

It is to be noted that the size and position of the detection event region and the data display region may both be set according to actual situations. This application is not limited thereto.

In some embodiments, the electronic device may display a detection event in a detection event region and a processing category to which the detection event belongs, and display real-time detection data in different dimensions of the detection event in a data display region, for example, only displaying the total number of machine review contents at the current time and the number of contents passing the machine review.

In other embodiments, the electronic device may also display real-time detection data in the data display region concurrently with detection data obtained at historical times, for example, displaying the collected detection data and detection data obtained at historical times in a line graph (time in a horizontal axis and detection data in a vertical axis) to facilitate display of changes in the detection data in the time dimension.

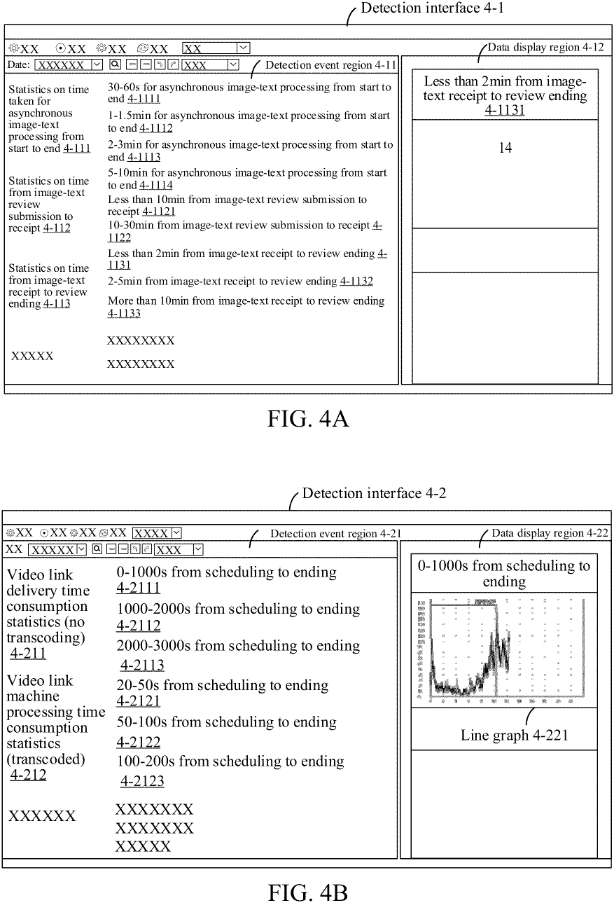

Exemplarily, FIG. 4A is a schematic diagram of a detection event and detection data according to an embodiment of this application. In a detection event region 4-11 of a detection interface 4-1, several detection events and service processing to which the detection events belong are displayed. For example, four detection events are displayed, namely, 30-60 s for asynchronous image-text processing from start to end 4-1111, 1-1.5 min for asynchronous image-text processing from start to end 4-1112, 2-3 min for asynchronous image-text processing from start to end 4-1113, and 5-10 min for asynchronous image-text processing from start to end 4-1114. Service processing to which the detection events belong is also displayed, namely, statistics on time taken for asynchronous image-text processing from start to end 4-111. Two detection events are displayed, namely, less than 10 min from image-text review submission to receipt 4-1121 and 10-30 min from image-text review submission to receipt 4-1122. Service processing to which the detection events belong is also displayed, namely, statistics on time from image-text review submission to receipt 4-112. Detection events are displayed, namely, less than 2 min from image-text receipt to review ending 4-1131, 2-5 min from image-text receipt to review ending 4-1132, and more than 10 min from image-text receipt to review ending 4-1133. Service processing to which the detection events belong is also displayed, namely, statistics on time from image-text receipt to review ending 4-113. In a data display region 4-12, real-time detection data 14 of less than 2 min from image-text receipt to review ending 4-1131 is displayed (which may be displayed when selected by a user).

FIG. 4B is another schematic diagram of a detection event and detection data according to an embodiment of this application. In a detection event region 4-21 of a detection interface 4-2, service processing to which three detection events belong, namely, video link delivery time consumption statistics (no transcoding) 4-211 is displayed, where the three detection events are 0-1000 s from scheduling to ending 4-2111, 1000-2000 s from scheduling to ending 4-2112, and 2000-3000 s from scheduling to ending 4-2113. Service processing to which three detection events belong, namely, video link machine processing time consumption statistics (transcoded) 4-212 is displayed, where the three detection events are 20-50 s from scheduling to ending 4-2121, 50-100 s from scheduling to ending 4-2122, and 100-200 s from scheduling to ending 4-2123. In a data display region 4-22, a line graph 4-221 (which may be displayed when selected by the user, time in a horizontal axis and quantity in a vertical axis) for 0-1000 s from scheduling to ending is displayed.

In this embodiment of this application, the detection interface may be displayed before the data detection flow starts, or may be displayed after the detection data is collected. The detection interface may be displayed in response to the operation of the operator or may be displayed regularly, which is not limited herein.

It is to be understood that, compared with the case where processing nodes on a data processing link detect respective service scenes and the service scenes inside the processing nodes can only be captured in the related art, in this embodiment of this application, by using processing information of different processing nodes for a target content, a processing situation of the processing nodes for the target content can be specified. By using circulation information determined according to different processing information, a circulation situation of the target content in different processing nodes can be specified. By determining whether any one of the processing information and the circulation information hits an event trigger condition, whether events occurring when processing nodes perform respective service processing in a data processing link or events occurring when content is in a circulation process can be captured and data collection can be performed to obtain corresponding detection data, thereby expanding a detection range of data detection and finally improving the anomaly detection rate of the data processing link. Also, compared with the related art in which data detected by the processing nodes is displayed separately, in this embodiment of this application, an electronic device may uniformly display the detection data of all the detection events in a data display region of a detection interface, whereby only one display view needs to be generated to complete the display of the detection interface without occupying additional computing resources.

It is to be noted that when the electronic device is implemented as a terminal, the processes of S101-S105 are all implemented by the terminal. When the electronic device is implemented as a server, the processes of S101-S104 may be implemented by the server, and the server controls a front end corresponding thereto to implement the process of S105.

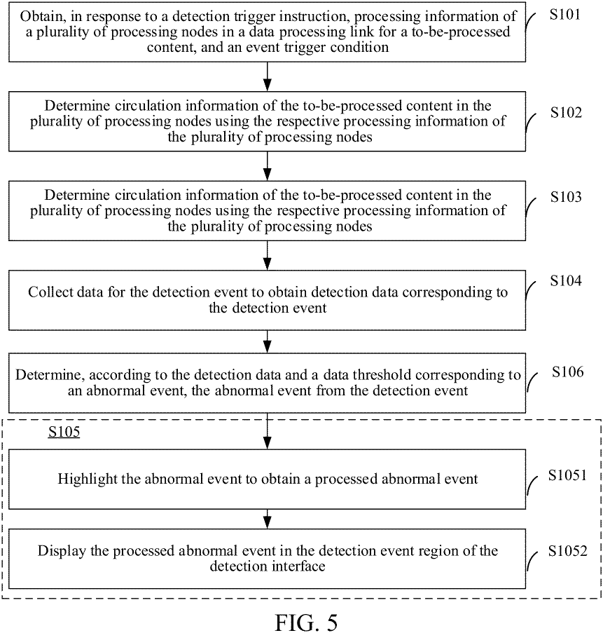

Based on FIG. 3, reference is made to FIG. 5. FIG. 5 is another schematic flowchart of a data detection method according to an embodiment of this application. In some embodiments of this application, after collecting data for the detection event to obtain detection data corresponding to the detection event and before displaying the detection event in a detection event region of a displayed detection interface, namely after S104 and before S105, the method may further include the following S106:

S106: Determine, according to the detection data and a data threshold corresponding to an abnormal event, the abnormal event from the detection event.

In this embodiment of this application, after obtaining the detection data, the electronic device can also determine that an abnormal event occurs in the detection event based on the detection data. At this moment, the electronic device may first obtain a data threshold corresponding to the abnormal event, and then compare the detection data with the obtained data threshold to find the abnormal event in the detection event.

It is to be understood that the data threshold of the abnormal event may be an extreme value of the set normal detection data or a fluctuation range of the detection data. The data threshold of the abnormal event may also be a mean value of previous detection data of the electronic device or automatically set by the processing node at the current processing performance. This embodiment of this application is not limited thereto.

In some embodiments, the data threshold is an extreme value of normal detection data. The electronic device may extract, as the abnormal event, an event in which the detection data is greater than the data threshold from the detection event. In other embodiments, the data threshold is a fluctuation range of abnormal detection data. The electronic device may further extract, as the abnormal event, an event in which the detection data is in the fluctuation range from the detection event.

It is to be noted that when a plurality of dimensions of data are present in a detection event, the electronic device may determine the detection event as an abnormal event when the data in any one of the dimensions exceeds a data threshold.

With continued reference to FIG. 5, in this embodiment of this application, the process of displaying the detection event in a detection event region of a displayed detection interface in S105 may be the following S1051-S1052:

S1051: Highlight the abnormal event to obtain a processed abnormal event.

S1052: Display the processed abnormal event in the detection event region of the detection interface.

After the electronic device determines an abnormal event, in order to enable the operator to know the abnormal event more quickly and to locate a problem, the electronic device may highlight the abnormal event such as bold, blinking, or tracing in red, and then display the highlighted abnormal event in the detection event region.

It is to be understood that when an abnormal event is determined since data of any one dimension of the detection event exceeds a corresponding data threshold, the electronic device may also highlight and display the data dimension of the data threshold to further remind the operator to the specific circumstances of the abnormal event.

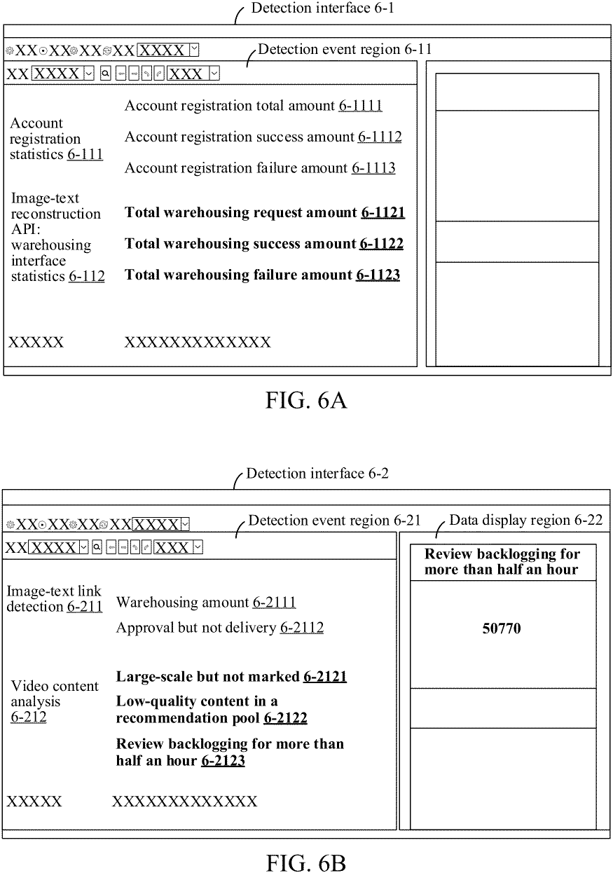

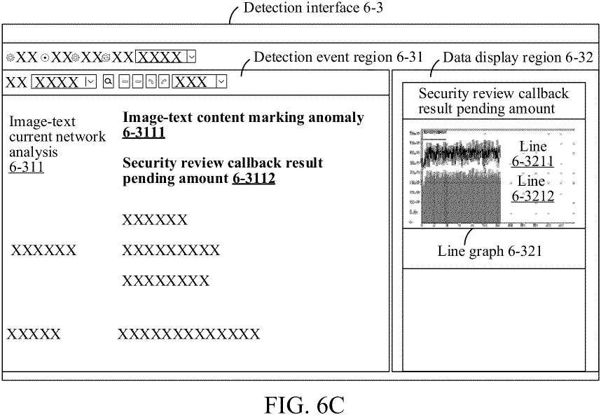

Exemplarily, FIG. 6A is a schematic diagram of an abnormal event according to an embodiment of this application. In a detection event region 6-11 of a detection interface 6-1, three normal detection events: an account registration total amount 6-1111, an account registration success amount 6-1112 and an account registration failure amount 6-1113 are displayed. Service processing to which the three normal detection events belong, namely, account registration statistics 6-111 is also displayed. Also, three abnormal events: a total warehousing request amount 6-1121, a total warehousing success amount 6-1122, and a total warehousing failure amount 6-1123 are displayed in bold. Service processing to which the abnormal detection events belong, namely, image-text reconstruction API: warehousing interface statistics 6-112 is also displayed.

FIG. 6B is another schematic diagram of an abnormal event according to an embodiment of this application. In a detection event region 6-21 of a detection interface 6-2, two normal detection events: a warehousing amount 6-2111 and approval but not delivery 6-2112 are displayed. Service processing to which the detection events belong is also displayed, namely, image-text link detection 6-211. Three abnormal events: large-scale review but not marked 6-2121, low-quality content in a recommendation pool 6-2122, and review backlogging for more than half an hour 6-2123 are displayed in bold. Service processing to which the abnormal events belong is also displayed, namely, video content analysis 6-212. Also, in a data display region 6-22 of the detection interface 6-2, a real-time quantity of the abnormal event: review backlogging for more than half an hour is displayed (which may be displayed when the abnormal event is selected), namely, 50770.

FIG. 6C is yet another schematic diagram of an abnormal event according to an embodiment of this application. In a detection event region 6-31 of a detection interface 6-3, two abnormal events: image-text content marking anomaly 6-3111 and a security review callback result pending amount 6-3112 are displayed in bold. Service processing to which the two abnormal events belong is also displayed, namely, image-text current network analysis 6-311. Also, in a data display region 6-32, a line graph 6-321 (time in a horizontal axis and quantity in a vertical axis) of the security review callback result pending amount is also displayed, where a line 6-3211 is an abnormal quantity change. A line 6-3212 is a normal quantity change of concurrent reference.

It is to be noted that in addition to highlighting and displaying the abnormal event, the electronic device may also generate alarm information such as a mail and a short message for the abnormal event by invoking an alarm platform, and send the alarm information to the corresponding operator so as to assist in improving the processing efficiency for the abnormal event.

In this embodiment of this application, the electronic device is capable of locating an abnormal event from the detection events according to the detection data and the data threshold, and displaying the abnormal event differently from other detection events in a normal situation, so as to assist in improving the location efficiency of anomalies of the data processing link.

In some embodiments of this application, the data threshold includes: an extreme threshold and a fluctuation threshold. In this case, the specific process of determining, according to the detection data and a data threshold corresponding to an abnormal event, the abnormal event from the detection event in S106 may be implemented by any one or more of the following processing: determining the detection event as the abnormal event when an extreme value of the detection data exceeds the extreme threshold corresponding to the abnormal event; and determining the detection event as the abnormal event when a fluctuation value of the detection data exceeds the fluctuation threshold corresponding to the abnormal event.

It is to be understood that the extreme value of the detection data may be a maximum or minimum value in the detection data, whereby the extreme threshold may be a maximum or minimum threshold. The electronic device compares the extreme value of the detection data with the extreme threshold. When it is determined that the maximum value of the detection data is greater than the maximum threshold or the minimum value of the detection data is less than the minimum threshold, it is determined that the detection event is abnormal, and the detection event is determined as an abnormal event.

In some cases, the detection data may fluctuate over time, for example, account registrations may be more in the evening and less in the morning. The electronic device calculates a fluctuation value of the detection data, then compares the fluctuation value with the fluctuation threshold, and determines the detection event as an abnormal event when the fluctuation value is greater than the fluctuation threshold. For example, machine review time taken for image-text data generally does not differ too much. If the machine review time fluctuates greatly, it is indicated that congestion occurs in the machine review link and the review algorithm is inappropriate, whereby it is necessary to determine the machine review time exceeding the fluctuation threshold as an abnormal event.

In this embodiment of this application, the electronic device may compare the extreme value of the detection data with the extreme threshold, or compare the fluctuation value of the detection data with the fluctuation threshold, so as to accurately determine whether the detection event is an abnormal event, so as to improve the accuracy of the abnormal event detection.

In some embodiments of this application, after displaying the processed abnormal event in the detection event region of the detection interface, namely, after S1052, the method may further include the following processing: screening out an abnormal content causing the abnormal event from the target content in response to a viewing trigger operation for the abnormal event; switching from the detection interface to a circulation information interface; and displaying, in the circulation information interface, abnormal sub-circulation information corresponding to the abnormal content in the circulation information.

When the electronic device detects that the operator performs a viewing trigger operation on the abnormal event in the detection event region, it will be determined that the operator needs to find the cause of the abnormal event. At this moment, the electronic device may parse the circulation information of the target content, or read the field of the processing information generated by the processing node for the target content, so as to determine contents causing the abnormal event from the target content, thereby obtaining abnormal contents.

Exemplarily, the electronic device may parse from the circulation information to obtain time taken for the target content to enter a certain processing node (for example, a machine review node or a manual review node) and pick out contents that take more time than a time threshold as abnormal contents causing the abnormal event: long time taken for the data processing link. The electronic device may further obtain abnormal contents causing the abnormal event including an abnormal image by reading a field in the processing information that represents whether the target content includes the abnormal image, thereby specifying which content includes the abnormal image.

It is to be understood that the viewing trigger operation may be a click, double click, long press, slide, and other operations for the abnormal event. This embodiment of this application is not limited thereto.

It is also to be understood that the circulation information interface is used for displaying the circulation information of the abnormal contents. The circulation information interface may completely cover the detection interface, or may occupy only a part of the detection interface. For example, a display window is superimposed on the detection interface, and the circulation information interface is displayed on the display window. Then, the electronic device may load the abnormal sub-circulation information corresponding to the abnormal contents into the circulation information interface so as to display the processing sequence and processing time consumption of the plurality of processing nodes for the abnormal contents. That is to say, the abnormal sub-circulation information represents the processing situation of the plurality of processing nodes for the abnormal contents according to a time sequence.

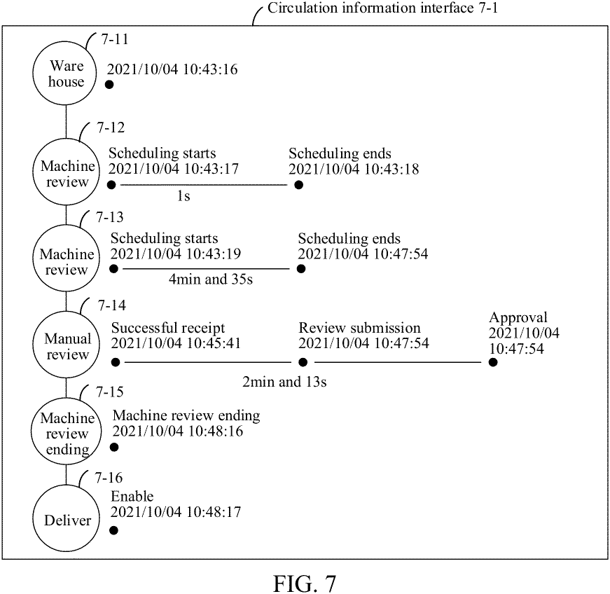

Exemplarily, FIG. 7 is a schematic diagram of abnormal sub-circulation information according to an embodiment of this application. Abnormal sub-circulation information displayed in a circulation information interface 7-1 includes: time of warehousing 7-11 (namely, starting the processing of a data processing link) 2021/10/04 10:43:16; scheduling start time for machine review 7-12 (processing node) 2021/10/04 10:43:17, scheduling end time for machine review 7-12 2021/10/04 10:43:18, and time taken for machine review 7-12: 1 s; scheduling start time for machine review 7-13 (processing node) 2021/10/04 10:43:19, scheduling end time for machine review 7-13 2021/10/04 10:47:54, and time taken for machine review 7-13: 4 min and 35 s; time 2021/10/04 10:45:41 for successful receipt of manual review 7-14 (processing node), time 2021/10/04 10:47:54 for review submission, time 2021/10/04 10:47:54 for approval, and time 2 min and 13 s for manual review 7-14; time of machine review ending 7-15: 2021/10/04 10:48:16; time enabled in delivery 7-16: 2021/10/04 10:48:17.

In this embodiment of this application, the electronic device is also capable of determining an abnormal content, and displaying abnormal sub-circulation information of the abnormal content to an operator, so as to provide processing situations of a plurality of processing nodes for the abnormal content via the abnormal sub-circulation information, thereby improving the location efficiency of anomalies of a data processing link.

In some embodiments of this application, before obtaining, in response to a detection trigger instruction, processing information of a plurality of processing nodes in a data processing link for a target content, and an event trigger condition, namely, before S101, the method may further include the following processing: displaying a rule configuration region in response to a selecting operation for a rule configuration option in a displayed configuration interface, and displaying a historical configuration condition in a historical condition sub-region of the rule configuration region; screening out, in response to a designation operation for a service designation sub-region of the rule configuration region, a to-be-configured service from a plurality of candidate services displayed by the service designation sub-region; displaying a condition editing interface for the to-be-configured service in response to a trigger operation for a condition configuration identifier in the rule configuration region; obtaining a condition parameter for the to-be-configured service in response to an input operation for a condition parameter region of the condition editing interface, and determining a latest configuration condition of the to-be-configured service according to the condition parameter; and determining the latest configuration condition and the historical configuration condition as the event trigger condition.

It is to be noted that the historical configuration condition is displayed in the rule configuration region. The historical configuration condition is a condition that has been configured for a service responsible for the processing node, and is not limited to a specific service. It is to be understood that the configuration interface may be displayed in response to a configuration trigger operation by an operator or may be displayed regularly. This embodiment of this application is not limited thereto.

A service designation sub-region is provided in the rule configuration region, the candidate services displayed thereby refer to services for which the processing node designates the target content, and thus the candidate services represent services which need to detect the processing of the processing node. That is to say, in a processing node, different services may need to be processed on the target content, for example, scheduling services during machine review, specific review services, and the like. The processing of the services needs to be detected.

In some embodiments, the service designation sub-region may be a service selection window in which a plurality of candidate services are displayed. The electronic device may determine a selecting operation within the window as a designation operation and select the candidate service selected by the operator as the to-be-configured service.

In other embodiments, the service designation sub-region may be an information input window. The electronic device may regard an input operation within this window as a designation operation to determine the inputted candidate service as the to-be-configured service.

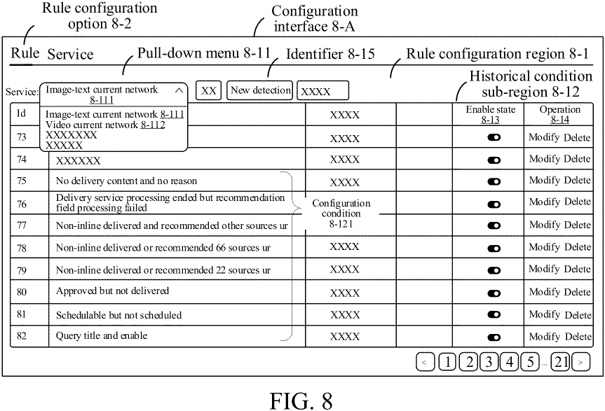

Exemplarily, FIG. 8 is a schematic diagram of determining a to-be-configured service according to an embodiment of this application. After a rule configuration option 8-2 of a configuration interface 8-A is triggered, a rule configuration region 8-1 will appear. In a pull-down menu 8-11 (service designation sub-region) of the rule configuration region 8-1, candidate services such as an image-text current network 8-111 and a video current network 8-112 are displayed. The operator may search for a service which needs to detect the processing by an up-down scrolling operation. When the electronic device detects that the operator has selected the image-text current network 8-111, the candidate service is determined as a to-be-configured service. Also, configured configuration conditions 8-121, enable states 8-13 of the configuration conditions, and available operations 8-14 such as modification and deletion are displayed in a historical condition sub-region 8-12 of the rule configuration region 8-1.

After determining the to-be-configured service, the electronic device determines whether to display a condition editing interface for the to-be-configured service by detecting whether a condition configuration identifier is triggered.

Exemplarily, with continued reference to FIG. 8, the condition editing interface is displayed when the electronic device detects that the operator clicks/taps (trigger operation) or doubly clicks/taps (trigger operation) a new detection identifier 8-15 (condition configuration identifier).

In the condition editing interface, a parameter region is provided. The electronic device may determine condition parameters of a to-be-matched service in condition configuration by obtaining contents inputted by the operator in the parameter region, and then generate a latest configuration condition for the to-be-configured service according to the condition parameters.

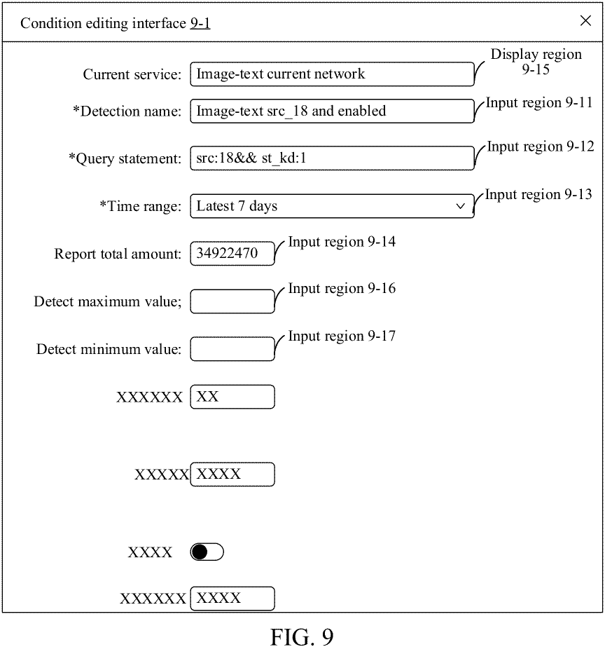

Exemplarily, FIG. 9 is a schematic diagram of a condition editing interface according to an embodiment of this application. In a condition editing interface 9-1, a detection name input region 9-11, a query statement input region 9-12, a time range input region 9-13, and a total amount reporting input region 9-14 are all condition parameter regions. A current service display region 9-15 displays the name of the to-be-configured service: image-text current network. The electronic device may determine src:18&&st_kd:1 inputted by the operator in the query statement input region 9-12 as a specific condition content of the to-be-configured service, determine image-text src_18 and enabled inputted in the detection name input region 9-11 as the name of the configuration condition, and determine last 7 days inputted in the time range input region 9-13 and 34922470 inputted in the total amount reporting input region 9-14 as a retrieval time range of the configuration condition. In this way, the electronic device can generate a configuration condition for the magnitude of content that an image-text src function field is equal to 18 when enabled. In addition, a detection maximum value input region 9-16, a detection minimum value input region 9-17, and the like may be provided in the condition editing interface 9-1 to further refine the configuration condition.

It is to be understood that through the condition editing interface, a personalized configuration channel can be provided for the data detection process to facilitate personalized configuration for the data detection of the data processing link, whereby the electronic device can more flexibly perform the data detection of the data processing link, thereby assisting in improving the anomaly detection rate of the data processing link.

In some embodiments of this application, before displaying a rule configuration region in response to a selecting operation for a rule configuration option in a displayed configuration interface, namely, before S107, the method may further include the following processing: displaying a service configuration region in response to a selecting operation for a service configuration option in the displayed configuration interface, and displaying a historical configuration service in a service display sub-region of the service configuration region; displaying a service creation interface in response to a trigger operation for a new service identifier in the service configuration region; obtaining a service parameter in response to an input operation for a service parameter region in the service creation interface, and generating a latest configuration service according to the service parameter; and determining the plurality of candidate services using the latest configuration service and the historical configuration service.

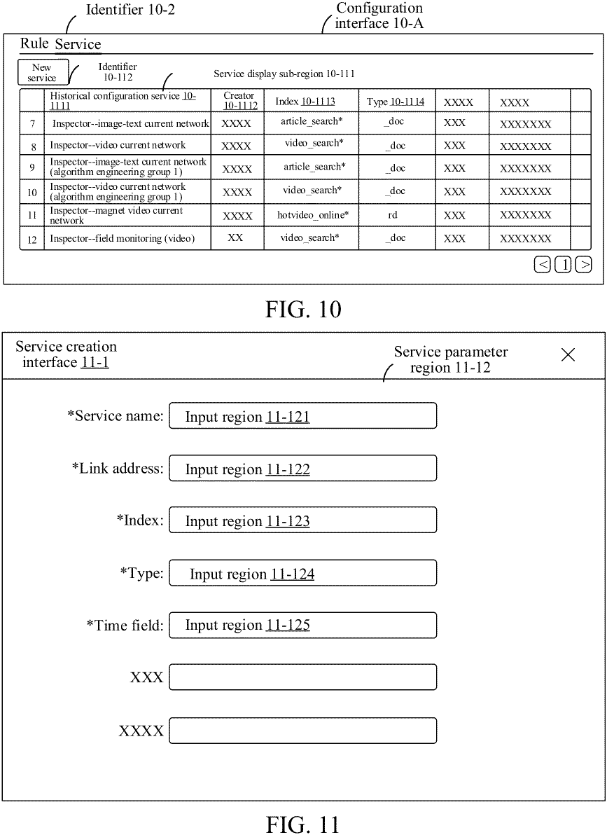

In this embodiment of this application, the electronic device further provides a service configuration region to provide candidate services that require data detection. Exemplarily, FIG. 10 is a schematic diagram of a service configuration region according to an embodiment of this application. In a service configuration region 10-1 of a configuration interface 10-A, a service display sub-region 10-111 and a new service identifier 10-112 are provided. A plurality of historical configuration services 10-1111 that have been generated, and information such as creators 10-1112, indexes 10-1113, and types 10-1114 of the service scenes are displayed in the service display sub-region 10-111. The service configuration region 10-1 is displayed when a service identifier (service configuration option) 10-2 is triggered. When the operator clicks/taps the new service identifier 10-112 in FIG. 10, a service creation interface pops up.

A service parameter region is provided in the service creation interface for inputting service parameters required by candidate services, for example, names, connection addresses, types, and the like. The electronic device then generates a latest configuration service according to the service parameters.

Exemplarily, FIG. 11 is a schematic diagram of a service creation interface according to an embodiment of this application. The electronic device may determine contents inputted by the operator in a service parameter region 11-12 provided in a service creation interface 11-1, for example, contents inputted in a service name input region 11-121, a link address input region 11-122, an index input region 11-123, a type input region 11-124, and a time field input region 11-125, as the service parameters to generate the latest configuration service.

In some embodiments, the electronic device may obtain a corresponding service template according to the types in the service parameters, and then adjust the service template using other parameters in the service parameters, such as names and link addresses, so as to obtain the latest configuration service. In other embodiments, the electronic device may directly integrate parameters such as names, link addresses, and types in a preset format to obtain the latest configuration service. This embodiment of this application is not limited thereto.

In this embodiment of this application, the electronic device may also configure and generate a candidate service which needs to perform data detection via service parameters obtained from a service creation interface, so as to enable the candidate service to be generated completely according to detection requirements, whereby data detection of a data processing link is more consistent with actual requirements and is also more flexible.

In some embodiments of this application, the specific process of obtaining, in response to a detection trigger instruction, processing information of a plurality of processing nodes in a data processing link for a target content in S101 may be implemented by the following processing: performing, in response to the detection trigger instruction, bypass backup on a processing result of each of the processing nodes for the target content to obtain bypass information of each of the processing nodes, and collecting the bypass information of each of the processing nodes via a message queue; and obtaining, from the message queue, the respective bypass information of the plurality of processing nodes to obtain the processing information of the plurality of processing nodes for the target content.

After each processing node finishes processing for the target content, a processing result for the target content is generated. It is to be understood that the processing result generated for the target content also needs to be transmitted to the next processing node, whereby the next processing node determines what kind of processing needs to be performed on the target content (for example, when the machine review result is approval, the next processing node of manual review, namely, manual review, will directly eliminate the review of the target content, and when the machine review result is not approval, the manual review will start the review of the target content). Therefore, in order not to affect the processing flow of the next processing node, the electronic device will bypass the processing result so as to obtain a “backup” of the processing result. The backup is bypass information. Then the electronic device collects the bypass information of each processing node using a message queue, and finally reads the bypass information from the message queue so as to obtain processing information of the target content respectively by the plurality of processing nodes.

In this embodiment of this application, the electronic device may decouple the detection process from the service logic of the processing node by bypassing the processing result generated by the processing node, whereby the data detection is independent of the processing of the processing node, namely, the data detection process does not affect the service logic of the data processing link, thereby improving the stability of the data processing link during data processing.

In some embodiments of this application, the processing information includes: a function field, review data, and time data. At this moment, the specific implementation of determining circulation information of the target content in the plurality of processing nodes using the respective processing information of the plurality of processing nodes in S102 may include the following processing: arranging and sorting the review data according to the time data to obtain a review experience of the target content; parsing the function field to obtain a preprocessing experience of the target content; and determining an integration result of the preprocessing experience and the review experience as the circulation information of the target content among the plurality of processing nodes.

The electronic device determines a precedence order of various review data through the time data, and then uses the precedence order to sort the review data, so as to obtain a review experience of the target content. It is to be noted that the review data includes a machine review result, a manual review result, and other data. The time data includes a review start time, an end time, and other data.

The preprocessing experience represents normalized processing for the target content before reviewed, namely, the above content processing. For example, the preprocessing experience may include a processing experience of image size compression, content formatting, and the like.

After obtaining the review experience and the preprocessing experience, the electronic device chronologically integrates the preprocessing experience and the review experience into a complete content experience of the target content. The content experience is circulation information of the target content among the plurality of processing nodes.

It is to be understood that the electronic device may provide the circulation situation of the target content among the plurality of processing nodes via the circulation information, whereby the electronic device can obtain more data for the data processing link to enhance the scope of the detection data.

In some embodiments of this application, after determining circulation information of the target content in the plurality of processing nodes using the respective processing information of the plurality of processing nodes, namely, after S102, the method may further include the following processing: displaying, in response to a trigger operation for an information query interface, the information query interface; obtaining, in response to an input operation for an information input region in the information query interface, a to-be-searched identifier corresponding to the to-be-searched content; extracting target sub-circulation information of the to-be-searched content from the circulation information according to the to-be-searched identifier; and switching from the information query interface to a circulation information interface in response to an interface switching operation, and displaying the target sub-circulation information on the circulation information interface.

In this embodiment of this application, the electronic device may further provide an entry for querying the circulation information of a specific content after determining the circulation information of the target content among the plurality of processing nodes. At this moment, the electronic device displays, in response to a trigger operation for an information query interface, the information query interface.

The electronic device obtains content inputted in an information input region in the information query interface, and determines the obtained content as a to-be-searched identifier of the to-be-searched content. The to-be-searched content is contained in the target content, namely, the to-be-searched content is all or a part of the target content.

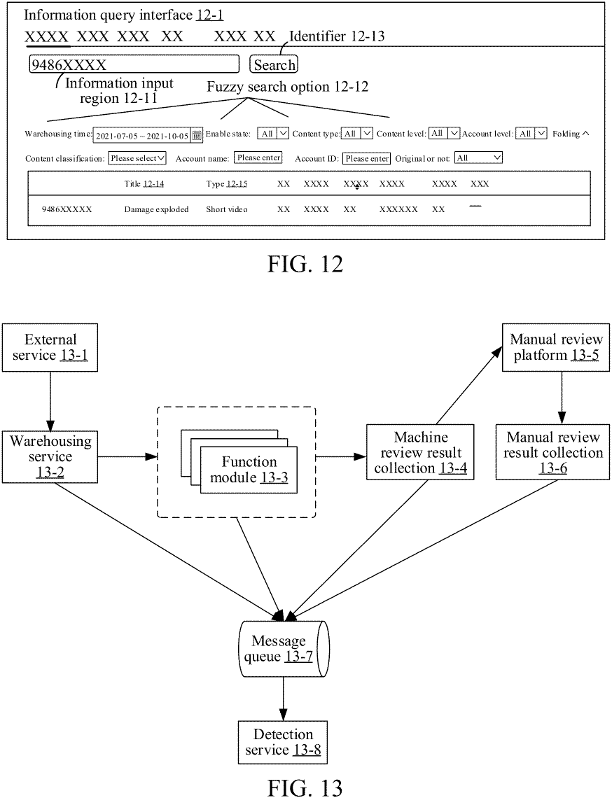

Exemplarily, FIG. 12 is an information query interface according to an embodiment of this application. In an information query interface 12-1, an information input region 12-11 is provided for inputting a to-be-searched identifier 9486XXXX. Other fuzzy search options 12-12 are also provided in the information query interface 12-1, so as to search out a plurality of sub-circulation information corresponding to different contents in batches via inputted fuzzy conditions.

Since the target content may contain a plurality of different contents, the circulation information also contains sub-circulation information corresponding to the plurality of contents, whereby the electronic device determines the obtained sub-circulation information hit by the content identifier as target sub-circulation information.

Exemplarily, with continued reference to FIG. 12, when detecting that the operator has triggered a search identifier 12-13, the electronic device queries the corresponding content according to the to-be-searched identifier 9486XXXX inputted by the operator, and displays basic information of the content, namely, a title 12-14, a type 12-15, and the like. When the operator clicks/taps the title 12-14 in the basic information, an interface switching operation is triggered to switch from the information query interface to the circulation information interface.

In this embodiment of this application, after obtaining the circulation information of the target content, the electronic device may extract and display target sub-circulation information from the obtained to-be-searched identifier. In this way, it is possible to provide a query entry for any content circulation situation, so as to simplify the difficulty of processing a query content.

In some embodiments of this application, the detection data includes at least: number of invocations for the processing node, number of generations of processing information representing the success of processing by the processing node, number of generations of processing information representing the failure of processing by the processing node, number of falls of processing time of the processing node for the target content within a preset time range, number of anomalies of an account of the target content, and quantity of abnormal fields contained in the target content. Further, the detection data may be collected by event tracking.

In some embodiments of this application, the specific implementation process of collecting data for the detection event to obtain detection data corresponding to the detection event in S104 may include the following processing: collecting, when a detection time point is reached, data of the detection event within the preset time range to obtain the detection data of the detection event.

It is to be noted that the preset time range may be set according to actual situations, for example, 3 months or 10 days. The preset time range may also be obtained by analyzing the importance of detection events in combination with an artificial intelligence technology. A longer time range (for example, more than 1 month) is set for detection events with higher importance (for example, higher than an importance threshold), whereby more detection data can be obtained for detection events with higher importance.

It is to be understood that in this embodiment of this application, the electronic device may obtain a data set of detection events by periodically obtaining data of the detection events within the preset time range. In this way, more detection data can be obtained for detection events, and the amount of data used for anomaly location can be improved, thereby assisting in improving the accuracy of anomaly location.

In this embodiment of this application, the plurality of processing nodes include: the warehousing processing node, the function processing node, and the review processing node, and the processing information of the plurality of processing nodes includes: content identifiers, review data, time data, and function fields. In this case, the specific implementation process of obtaining, in response to a detection trigger instruction, processing information of a plurality of processing nodes in a data processing link for a target content in S101 may be implemented by the following processing: obtaining, from a functional database, a content identifier allocated by the warehousing processing node for the target content, review data and time data reported by the review processing node for the target content, and a function field generated by the function processing node for the target content; and

When the warehousing processing node performs warehousing processing on the target content, a unique content identifier is generated for the target content, so as to use the content identifier to distinguish different contents. The content identifier may be a digital ID, a title field obtained by summarizing the target content, and the like. This embodiment of this application is not limited thereto. The review data is generated after the review processing node completes the review on the target content. The time data may be data such as time when the target content enters the review processing node, time when the review processing node completes the review, and review duration. The function field is generated by the function processing node after completing the function processing of the target content. The function field may include information such as an enable state, a valid time, and a detailed page URL of the target content. This embodiment of this application is not limited thereto.

It is to be noted that the content identifier, the function field, the review data, and the time data are synchronized to the functional database by a distributed database. A content identifier in the distributed database is received from the warehousing processing node. The function field is received from the function processing node. The review data and the time data are received from the review processing node. That is, the function processing node, the review processing node, and the warehousing processing node actively report the data generated thereby to the distributed database, and then the distributed database uniformly synchronizes to the functional database, whereby the electronic device directly reads the processing information of the processing node from the functional database. In this way, the functional database does not need to perform signaling interaction with the warehousing processing node, the function processing node, and the review processing node, whereby the functional database is decoupled from the processing nodes, and the service logic of the functional database is more concise.

Certainly, in some embodiments, the warehousing processing node, the function processing node, and the review processing node may also directly report the generated content identifier, function field, review data and time data to the functional database so as to improve the real-time performance of processing information obtaining.

In some embodiments, after collecting the content identifier, the function field, the review data, and the time data, the electronic device may correspondingly arrange and store the function field, the review data, and the time data of different contents according to the content identifier so as to obtain processing information respectively generated by the plurality of processing nodes for the target content. Certainly, the electronic device may also directly determine the content identifier, the function field, the review data, and the time data as processing information. This embodiment of this application is not limited thereto.

In some embodiments of this application, after displaying the processed abnormal event in the detection event region of the detection interface, namely, after S1052, the method may further include the following processing: invoking an alarm platform, generating alarm information for the abnormal event, and pushing the alarm information to a target object of the abnormal event.

The alarm information may be various forms of information, such as a short message, a mail, or a phone call. The target object of the abnormal event may refer to an operator responsible for the processing of the abnormal event. In this way, the electronic device can actively transmit alarm information of the abnormal event to the target object, whereby the abnormal event can be resolved and excluded in a shorter time, thereby assisting in improving the resolution efficiency of the abnormal event.

An exemplary application of this embodiment of this application in an actual application scene will be described below.

This embodiment of this application is realized in the scene of anomaly detection on a processing link of a content center (a platform for listing contents uploaded by a user and distributing the contents to other users). In this embodiment of this application, anomaly detection and alarm are realized through the coordinated operation of an alarm platform, an inspection platform and a visualization platform which are arranged in the background (electronic device), and life cycle viewing is performed on the content where an anomaly occurs.

Firstly, the inspection platform needs to detect, for each link (processing node) of a link (data processing link), warehousing creation, content modification, state torsion, and the like from upstream, also detects the success rate and anomaly rate of processing for each link. In addition, it is also necessary to detect some key situations, such as the time consumption of processing. When a service meeting a reporting condition occurs, data is reported to the alarm platform so as to determine whether to alarm. The inspection platform may collect data of the services by event tracking. The event tracking policy may include:
amount of requests: number of invocations of trigger service logic, which is generally used for detecting the magnitude of a sudden increase, for example, when a large number of retries occur in some special contents, an avalanche condition may occur;
amount of execution successes: number of response successes after triggering service execution, which is commonly used for detecting resource consumption, and the like, so as to prevent the upstream from occupying a large number of service resources;
amount of execution failures: number of response identifies after triggering service execution, which is commonly used for detecting the quality of service;
time consumption of phases: for different link environments, time-consuming detection needs to be performed in phases, for example, detection is performed according to a time range of 0-50 ms, 50-100 ms, 100-200 ms, ..., 1-2 s, and the like;
distribution of sources: when the content enters the content center, different service parties will be allocated with different source ids, and the server will also carry own source id when delivering the content, the background detects the distribution of different sources, and if there is a problem in the delivered content, an obvious source id aggregation will occur during the detection, so as to locate the problem;
account level: each account is bound to an author, and each account is rated according to the number of historical papers issued, the number of recommendations, the number of hits, and the like of the author, under normal circumstances, the account proportion of each level is stable, there will be no significant sudden increase or decrease, and the unexpected situation needs to be timely alarmed;
legitimacy of content: focusing on specific function fields, for example, a detailed page URL is an internally linked link, an account id is a numerical value of a legal scope content, and title and author fields must exist; and
combination policy: the above policies are combined, for example, the time consumption of phases is combined with the distribution of sources to detect the time consumption of each phase environment, and the distribution of sources is combined with the account level to detect the distribution of account levels from high to low in different sources.

The visualization platform may analyze the detailed processing flow (sub-circulation information) for a specific content. For example, a user may input a unique identifier of content (to-be-searched identifier) in a search box of an interface similar to that shown in FIG. 12. Then the visualization platform will respond to a search list and control a front end to display summary information corresponding to this identifier, such as a title, a content type, and a content class. When the user clicks/taps on an edit in the list, the life cycle (sub-circulation information) shown in FIG. 7 is displayed, such as description information and specific time points of the processing links experienced by the content in the life cycle.

The inspection platform may periodically detect a common abnormal situation, and the inspection platform may be used to configure an abnormal situation to be detected. A plurality of service parties are supported on the inspection platform, and the detection of each service party (candidate service) is independent of each other without affecting each other. The user may complete the configuration of the service parties by interacting with an interface similar to that shown in FIG. 10 and FIG. 11. If the user has already created service parties, the user may select the corresponding service party in a rule option (service designation sub-region) and query a created detection rule. The search results show the name of a rule, a creation name, an update time, and the like, and operations such as disable or enable, modification and deletion are performed for a rule. When the user creates a rule, an interface as shown in FIG. 9 pops up and fills in the required contents in the information box (condition parameter region) of the interface to configure the rule.

When the user creates rules, the inspection platform will screen out situations (abnormal events) needing to be reported to the alarm platform according to these rules, and the alarm platform supports an alarm policy so as to alarm when these situations are abnormal.

Specifically, the situations to be detected may include: distribution of warehousing sources, distribution of updating sources, distribution of delivery sources, distribution of time consumption for content processing, distribution of issuing account levels, distribution of time consumption for processing of the account levels, distribution of review submission types, change of content attribute fields, detection of legality of the content attribute fields, and the like.

The processing link and the detection process for each link in the processing link are described below.

FIG. 13 is a schematic diagram of a processing link according to an embodiment of this application. Referring to FIG. 13, the processing link includes an external service 13-1, a warehousing service 13-2, a function module 13-3, machine review result collection 13-4, a manual review platform 13-5, manual review result collection 13-6, a message queue 13-7, and a detection service 13-8 (the service may be provided by an inspection platform).

The external service 13-1 generally refers to a service for content input and is used for providing specific information such as image-text and video. Each external service is allocated with a source and carries content to be inputted (target content) to the warehousing service 13-2.

The warehousing service 13-2 (warehousing processing node) collects data such as image-text and video provided by each external service, creates content data on a link, and generates a unique rowkey identifier (content identifier). When the content creation is completed, relevant information of warehousing, such as a rowkey identifier and creation time, is put into a message queue, whereby the detection service 13-8 collects warehousing events (processing information).

The function module 13-3 (function processing node) refers to a micro-service (preprocessing experience) such as processing, classification and deduplication, account processing, and picture internal linking required in link processing. When processing the same content, a plurality of function modules may be needed at the same time, and the function modules all generate function fields related to the content, such as validity time, title vectorization results, and account levels. The function fields are indexed by a unique rowkey identifier, and dropped into a content store, and field change events are put into the message queue for collection by the detection service 13-8.

The machine review result collection 13-4 (review processing node) refers to that: when the content is processed by the function module, a plurality of function fields will be generated, and the machine review result collection module determines whether the content passes the review according to the function fields, and the specific image-text and video contents. If the content is too low in quality and there are already repeated contents and potential safety hazards, it is necessary to perform off-shelving, interception, etc. If the content is legal and is not intercepted by the machine review, it may be determined whether the delivery directly starts or review processing is performed again in the manual review module according to the fields such as account levels and the quality of content generated by the function module. The machine review result collection 13-4 will put a machine review result (processing information) in a message queue with a rowkey identifier to be collected by the detection service 13-8.

The manual review platform 13-5 (review processing node) refers to that: if the manual review result cannot determine whether to strike and intercept the content or deliver and enable the content, for example, there is a low-quality problem in the content of a high-quality account, and high-quality articles are duplicated on the Internet, the manual review platform 13-5 will perform professional review processing for these situations, and transmit the review results to the manual review result collection service 13-6.

The manual review result collection 13-6 (review processing node) refers to that: after the review of the manual review platform is completed, information such as review results and reasons for failure in the review will be carried to the manual review result collection 13-6. The manual review result collection 13-6 will perform delivery and enabling for the contents that have passed the review, perform off-shelving and interception for the contents that have failed the review, and record the reasons for failure. Also, the manual review result collection 13-6 will also record general manual review result information, such as review time and review personnel, and carry the rowkey identifier to the message queue for collection by the detection service 13-8.

The message queue 13-7 is a general storage for message collection and distribution, receives bypass messages transmitted by the warehousing service, the function module, the machine review result collection service, and the manual review result collection, and allows the detection service 13-8 to collect these messages as consumers.

The detection service 13-8 collects events such as content entry, machine review ending, manual review ending, and broadcast field change, parses information such as content rowkey identifiers and function fields in the event, and develops according to the detection requirements of specific services. For example, the distribution of entry sources and an entry magnitude (detection data) are detected according to a warehousing event (detection event). The magnitude of machine review approval, the magnitude of machine review non-approval, the distribution of machine review processing sources, and the distribution of machine review processing time consumptions are detected according to the machine review ending event. The magnitude of review submission, the distribution of review time consumptions, the distribution of review approval sources, and the distribution of review non-approval sources are detected according to the manual review ending event. The detection of deletion and off-shelving sources, a url non-internal linking magnitude, and a content enabling magnitude are detected according to the broadcast field change event.

In some embodiments, the inspection platform may periodically initiate detection of a detection situation, namely, firstly querying a corresponding detection rule (event trigger condition) according to configured service information, querying es storage (processing information and detection data) according to each detection rule, and providing to the alarm platform for alarm in the presence of a service complying with reporting.

The inspection platform requires service parties to report data, and the most common methods for reporting are Hbase synchronization and active reporting. In Hbase synchronization, the function fields are uniformly stored in the Hbase (distributed database), and there is a service to synchronize Hbase fields to a storage service (functional database). This mode is widely used because there is no perception of the function module. When actively reporting, the function module will report data required thereby to the storage service. This mode is used for requiring to provide personalized reporting, and therefore it is only necessary to perform active reporting by the service party.

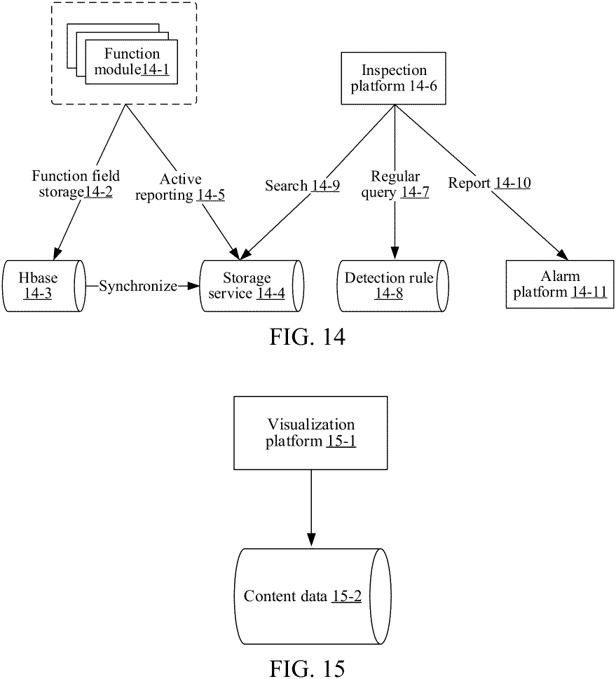

FIG. 14 is a schematic diagram of reporting a detection situation on an inspection platform according to an embodiment of this application. A function module 14-1 performs function field storage 14-2, so as to add function fields to a Hbase 14-3, and the Hbase 14-3 synchronizes to a storage service 14-4, or actively reports 14-5 the function field to the storage service 14-4. An inspection platform 14-6 regularly queries 14-7 a detection rule 14-8, then searches 14-9 for the storage service 14-4 so as to match a detection situation, and reports 14-10 to an alarm platform 14-11 if the detection situation is satisfied.

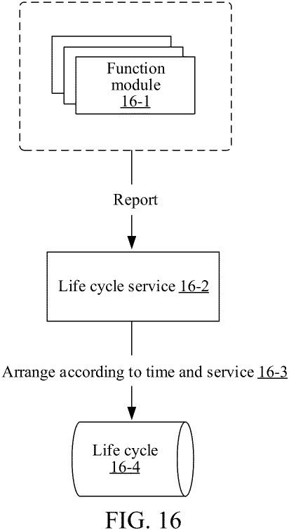

Exemplarily, FIG. 15 is a schematic flowchart of displaying a life cycle on a visualization platform according to an embodiment of this application. A visualization platform 15-1 queries content data 15-2 according to a rowkey identifier, so as to display the content data externally. FIG. 16 is a schematic diagram of generating a content experience according to an embodiment of this application. A function module 16-1 reports a content experience of the content to a life cycle service 16-2. The life cycle service 16-2 arranges 16-3 according to time and service. If review submission, receipt and review are set as a combination, the combinations are integrated according to a time sequence to obtain a life cycle 16-4.

In this way, full link data detection can be provided for a complex link environment, thereby extending the range of data detection, providing a life cycle of content to a user, and greatly increasing the efficiency of problem location.

It is to be understood that data relevant to user information and contents uploaded by users is involved in this embodiment of this application. When this embodiment of this application is applied to a particular product or technology, user approval or consent is required, and collection, use and processing of the relevant data is required to comply with relevant national and regional laws and regulations and standards.

An exemplary structure of the data detection apparatus 255 implemented as a software module according to this embodiment of this application is further described below. In some embodiments, as shown in FIG. 2, the software module stored in the data detection apparatus 255 of the memory 250 may include:
an information obtaining module 2551, configured to obtain, in response to a detection trigger instruction, processing information of a plurality of processing nodes in a data processing link for a target content, and an event trigger condition, the plurality of processing nodes including at least two of the following nodes: a warehousing processing node, a function processing node, and a review processing node;
an information arrangement module 2552, configured to determine circulation information of the target content in the plurality of processing nodes using the respective processing information of the plurality of processing nodes;
an event determination module 2553, configured to determine, when at least one of the processing information and the circulation information hits the event trigger condition, occurrence of a detection event corresponding to the event trigger condition in the data processing link;
a data collection module 2554, configured to collect data for the detection event to obtain detection data corresponding to the detection event; and
an information display module 2555, configured to display the detection event in a detection event region of a displayed detection interface, and display the detection data in a data display region of the detection interface.

In some embodiments of this application, the event determination module 2553 is further configured to determine, according to the detection data and a data threshold corresponding to an abnormal event, the abnormal event from the detection event.

The information display module 2555 is further configured to: highlight the abnormal event to obtain a processed abnormal event; and display the processed abnormal event in the detection event region of the detection interface.

In some embodiments of this application, the data threshold includes: an extreme threshold and a fluctuation threshold.

The event determination module 2553 is further configured to: determine the detection event as the abnormal event when an extreme value of the detection data exceeds the extreme threshold corresponding to the abnormal event; and determine the detection event as the abnormal event when a fluctuation value of the detection data exceeds the fluctuation threshold corresponding to the abnormal event.

In some embodiments of this application, the data detection apparatus 255 further includes: an information screening module 2556, configured to screen out an abnormal content causing the abnormal event from the target content in response to a viewing trigger operation for the abnormal event.

The information display module 2555 is further configured to: switch from the detection interface to a circulation information interface; and display, in the circulation information interface, abnormal sub-circulation information corresponding to the abnormal content in the circulation information. The abnormal sub-circulation information represents a processing situation of the plurality of processing nodes for the abnormal content according to a time sequence.

In some embodiments of this application, the data detection apparatus 255 further includes: an information configuration module 2557, configured to: screen out, in response to a designation operation for a service designation sub-region of the rule configuration region, a to-be-configured service from a plurality of candidate services displayed by the service designation sub-region, the candidate services representing services required to detect processing of the processing nodes; obtain a condition parameter for the to-be-configured service in response to an input operation for a condition parameter region of the condition editing interface, and determine a latest configuration condition of the to-be-configured service according to the condition parameter; and determine the latest configuration condition and the historical configuration condition as the event trigger condition.

The information display module 2555 is further configured to: display a rule configuration region in response to a selecting operation for a rule configuration option in a displayed configuration interface, and display a historical configuration condition in a historical condition sub-region of the rule configuration region; and display a condition editing interface for the to-be-configured service in response to a trigger operation for a condition configuration identifier in the rule configuration region.

In some embodiments of this application, the information display module 2555 is further configured to: display a service configuration region in response to a selecting operation for a service configuration option in the displayed configuration interface, and display a historical configuration service in a service display sub-region of the service configuration region; and display a service creation interface in response to a trigger operation for a new service identifier in the service configuration region.

The information configuration module 2557 is further configured to: obtain a service parameter in response to an input operation for a service parameter region in the service creation interface, and generate a latest configuration service according to the service parameter; and determine the plurality of candidate services using the latest configuration service and the historical configuration service.

In some embodiments of this application, the information obtaining module 2551 is further configured to: perform, in response to the detection trigger instruction, bypass backup on a processing result of each of the processing nodes for the target content to obtain bypass information of each of the processing nodes, and collect the bypass information of each of the processing nodes via a message queue; and obtain, from the message queue, the respective bypass information of the plurality of processing nodes to obtain the processing information of the plurality of processing nodes for the target content.

In some embodiments of this application, the processing information includes: a function field, review data, and time data. The information arrangement module 2552 is further configured to: arrange and sort the review data according to the time data to obtain a review experience of the target content; parse the function field to obtain a preprocessing experience of the target content, the preprocessing experience representing normalized processing for the target content when reviewed; and determine an integration result of the preprocessing experience and the review experience as the circulation information of the target content among the plurality of processing nodes.

In some embodiments of this application, the information configuration module 2557 is further configured to display, in response to a trigger operation for an information query interface, the information query interface.

The information obtaining module 2551 is further configured to obtain, in response to an input operation for an information input region in the information query interface, a to-be-searched identifier corresponding to the to-be-searched content. The to-be-searched content is contained in the target content.

The information screening module 2556 is further configured to extract target sub-circulation information of the to-be-searched content from the circulation information according to the to-be-searched identifier.

The information configuration module 2557 is further configured to switch from the information query interface to a circulation information interface in response to an interface switching operation, and display the target sub-circulation information on the circulation information interface.

In some embodiments of this application, the data collection module 2554 is further configured to collect, when a detection time point is reached, data of the detection event within the preset time range to obtain the detection data of the detection event.

In some embodiments of this application, the plurality of processing nodes include: the warehousing processing node, the function processing node, and the review processing node, and the processing information of the plurality of processing nodes includes: content identifiers, review data, time data, and function fields. The information obtaining module 2551 is further configured to obtain, from a functional database, a content identifier allocated by the warehousing processing node for the target content, review data and time data reported by the review processing node for the target content, and a function field generated by the function processing node for the target content. The content identifier, the function field, the review data, and the time data are synchronized to the functional database by a distributed database. A content identifier in the distributed database is received from the warehousing processing node. The function field is received from the function processing node. The review data and the time data are received from the review processing node.

In some embodiments of this application, the information configuration module 2557 is further configured to invoke an alarm platform, generate alarm information for the abnormal event, and push the alarm information to a target object of the abnormal event.

This embodiment of this application provides a computer program product or computer program. The computer program product or computer program includes computer instructions. The computer instructions are stored in a computer-readable storage medium. A processor of a computing device (an implementation of an electronic device) reads the computer instructions from the computer-readable storage medium. The processor executes the computer instructions, whereby the computing device performs the data detection method according to the foregoing embodiment of this application.

This embodiment of this application provides a computer-readable storage medium storing executable instructions. The executable instructions are stored therein. When executed by a processor, the executable instructions may trigger the processor to perform the data detection method according to this embodiment of this application, for example, the data detection method shown in FIG. 3.

In some embodiments, the computer-readable storage medium may be a memory such as FRAM, ROM, PROM, EPROM, EEPROM, flash memory, magnetic surface memory, optical disc, or CD-ROM. Various devices including one or any combination of the foregoing memories are also possible.

In some embodiments, the executable instructions may take the form of program, software, software module, script, or code, may be written in any form of programming language (including compiled or interpreted languages, or declarative or procedural languages), and may be deployed in any form, including as a stand-alone program or as a module, component, subroutine, or another unit suitable for use in a computing environment.

By way of example, the executable instructions may, but need not, correspond to files in a file system, and may be stored in a portion of a file that stores other programs or data, for example, in one or more scripts in a hyper text markup language (HTML) document, in a single file dedicated to the program in question, or in a plurality of coordinated files (for example, files that store one or more modules, subroutines, or portions of code).

By way of example, the executable instructions may be deployed to be executed on one computing device, or on a plurality of computing devices located at one site, or on a plurality of computing devices distributed across a plurality of sites and interconnected by a communication network. In this application, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules.

In summary, according to this embodiment of this application, whether events occurring when processing nodes perform respective service processing in a data processing link or events occurring when content is in a circulation process can be captured and data collection can be performed to obtain corresponding detection data, thereby expanding a detection range of data detection and finally improving the anomaly detection rate of the data processing link. Also, in this embodiment of this application, an electronic device may uniformly display the detection data of all the detection events in a data display region of a detection interface, whereby only one display view needs to be generated to complete the display of the detection interface without occupying additional computing resources.

The foregoing descriptions are merely embodiments of this application and are not intended to limit the protection scope of this application. Any modification, equivalent replacement, and improvement made without departing from the spirit and principle of this application fall within the protection scope of this application.

What is claimed is:

1. A data detection method, performed by an electronic device, the method comprising:
obtaining, in response to a detection trigger instruction, processing information of a plurality of processing nodes in a data processing link for a target content and a corresponding event trigger condition;
determining circulation information of the target content in the plurality of processing nodes using the respective processing information of the plurality of processing nodes;
determining, when at least one of the processing information and the circulation information hits the event trigger condition, occurrence of a detection event corresponding to the event trigger condition in the data processing link;
collecting data for the detection event to obtain detection data corresponding to the detection event; and
displaying the detection event in a detection event region of a detection interface, the detection data in a data display region of the detection interface.

2. The method according to claim 1, wherein after the collecting data for the detection event to obtain detection data corresponding to the detection event, the method further comprises:
determining, according to the detection data and a data threshold corresponding to an abnormal event, the abnormal event from the detection event;
highlighting the abnormal event to obtain a processed abnormal event; and
displaying the processed abnormal event in the detection event region of the detection interface.

3. The method according to claim 1, wherein the obtaining, in response to a detection trigger instruction, processing information of a plurality of processing nodes in a data processing link for a target content comprises:
performing, in response to the detection trigger instruction, bypass backup on a processing result of each of the processing nodes for the target content to obtain bypass information of each of the processing nodes, and collecting the bypass information of each of the processing nodes via a message queue; and
obtaining, from the message queue, the respective bypass information of the plurality of processing nodes to obtain the processing information of the plurality of processing nodes for the target content.

4. The method according to claim 1, wherein the processing information comprises: a function field, review data, and time data; the determining circulation information of the target content in the plurality of processing nodes using the respective processing information of the plurality of processing nodes comprises:
arranging and sorting the review data according to the time data to obtain a review experience of the target content;
parsing the function field to obtain a preprocessing experience of the target content, the preprocessing experience representing normalized processing for the target content before reviewed; and
determining an integration result of the preprocessing experience and the review experience as the circulation information of the target content among the plurality of processing nodes.

5. The method according to claim 1, wherein after the determining circulation information of the target content in the plurality of processing nodes using the respective processing information of the plurality of processing nodes, the method further comprises:
displaying, in response to a trigger operation for an information query interface, the information query interface;
obtaining, in response to an input operation for an information input region in the information query interface, a to-be-searched identifier corresponding to the to-be-searched content, the to-be-searched content being contained in the target content;
extracting target sub-circulation information of the to-be-searched content from the circulation information according to the to-be-searched identifier; and
switching from the information query interface to a circulation information interface in response to an interface switching operation, and displaying the target sub-circulation information on the circulation information interface.

6. The method according to claim 1, wherein the detection data comprises at least:
number of invocations for the processing node, number of generations of processing information representing the success of processing by the processing node, number of generations of processing information representing the failure of processing by the processing node, number of processing time of the processing node for the target content within a preset time range, number of anomalies of an account of the target content, and quantity of abnormal fields contained in the target content.

7. The method according to claim 1, wherein the collecting data for the detection event to obtain detection data corresponding to the detection event comprises:
collecting, when a detection time point is reached, data of the detection event within the preset time range to obtain the detection data of the detection event.

8. An electronic device for data detection, the electronic device comprising:
a memory, configured to store executable instructions; and
a processor, configured to implement, when executing the executable instructions stored in the memory, a data detection method, the method including:
obtaining, in response to a detection trigger instruction, processing information of a plurality of processing nodes in a data processing link for a target content and a corresponding event trigger condition;
determining circulation information of the target content in the plurality of processing nodes using the respective processing information of the plurality of processing nodes;
determining, when at least one of the processing information and the circulation information hits the event trigger condition, occurrence of a detection event corresponding to the event trigger condition in the data processing link;
collecting data for the detection event to obtain detection data corresponding to the detection event; and
displaying the detection event in a detection event region of a detection interface, the detection data in a data display region of the detection interface.

9. The electronic device according to claim 8, wherein after the collecting data for the detection event to obtain detection data corresponding to the detection event, the method further comprises:
determining, according to the detection data and a data threshold corresponding to an abnormal event, the abnormal event from the detection event;
highlighting the abnormal event to obtain a processed abnormal event; and
displaying the processed abnormal event in the detection event region of the detection interface.

10. The electronic device according to claim 8, wherein the obtaining, in response to a detection trigger instruction, processing information of a plurality of processing nodes in a data processing link for a target content comprises:
performing, in response to the detection trigger instruction, bypass backup on a processing result of each of the processing nodes for the target content to obtain bypass information of each of the processing nodes, and collecting the bypass information of each of the processing nodes via a message queue; and
obtaining, from the message queue, the respective bypass information of the plurality of processing nodes to obtain the processing information of the plurality of processing nodes for the target content.

11. The electronic device according to claim 8, wherein the processing information comprises: a function field, review data, and time data; the determining circulation information of the target content in the plurality of processing nodes using the respective processing information of the plurality of processing nodes comprises:
arranging and sorting the review data according to the time data to obtain a review experience of the target content;
parsing the function field to obtain a preprocessing experience of the target content, the preprocessing experience representing normalized processing for the target content before reviewed; and
determining an integration result of the preprocessing experience and the review experience as the circulation information of the target content among the plurality of processing nodes.

12. The electronic device according to claim 8, wherein after the determining circulation information of the target content in the plurality of processing nodes using the respective processing information of the plurality of processing nodes, the method further comprises:
displaying, in response to a trigger operation for an information query interface, the information query interface;
obtaining, in response to an input operation for an information input region in the information query interface, a to-be-searched identifier corresponding to the to-be-searched content, the to-be-searched content being contained in the target content;
extracting target sub-circulation information of the to-be-searched content from the circulation information according to the to-be-searched identifier; and
switching from the information query interface to a circulation information interface in response to an interface switching operation, and displaying the target sub-circulation information on the circulation information interface.

13. The electronic device according to claim 8, wherein the detection data comprises at least: number of invocations for the processing node, number of generations of processing information representing the success of processing by the processing node, number of generations of processing information representing the failure of processing by the processing node, number of processing time of the processing node for the target content within a preset time range, number of anomalies of an account of the target content, and quantity of abnormal fields contained in the target content.

14. The electronic device according to claim 8, wherein the collecting data for the detection event to obtain detection data corresponding to the detection event comprises:
collecting, when a detection time point is reached, data of the detection event within the preset time range to obtain the detection data of the detection event.

15. A non-transitory computer-readable storage medium, storing executable instructions, the executable instructions, when executed by a processor of an electronic device, causing the electronic device to perform a data detection method including:
obtaining, in response to a detection trigger instruction, processing information of a plurality of processing nodes in a data processing link for a target content and a corresponding event trigger condition;
determining circulation information of the target content in the plurality of processing nodes using the respective processing information of the plurality of processing nodes;
determining, when at least one of the processing information and the circulation information hits the event trigger condition, occurrence of a detection event corresponding to the event trigger condition in the data processing link;
collecting data for the detection event to obtain detection data corresponding to the detection event; and
displaying the detection event in a detection event region of a detection interface, the detection data in a data display region of the detection interface.

16. The non-transitory computer-readable storage medium according to claim 15, wherein after the collecting data for the detection event to obtain detection data corresponding to the detection event, the method further comprises:
determining, according to the detection data and a data threshold corresponding to an abnormal event, the abnormal event from the detection event;
highlighting the abnormal event to obtain a processed abnormal event; and
displaying the processed abnormal event in the detection event region of the detection interface.

17. The non-transitory computer-readable storage medium according to claim 15, wherein the obtaining, in response to a detection trigger instruction, processing information of a plurality of processing nodes in a data processing link for a target content comprises:
performing, in response to the detection trigger instruction, bypass backup on a processing result of each of the processing nodes for the target content to obtain bypass information of each of the processing nodes, and collecting the bypass information of each of the processing nodes via a message queue; and
obtaining, from the message queue, the respective bypass information of the plurality of processing nodes to obtain the processing information of the plurality of processing nodes for the target content.

18. The non-transitory computer-readable storage medium according to claim 15, wherein the processing information comprises: a function field, review data, and time data; the determining circulation information of the target content in the plurality of processing nodes using the respective processing information of the plurality of processing nodes comprises:
arranging and sorting the review data according to the time data to obtain a review experience of the target content;
parsing the function field to obtain a preprocessing experience of the target content, the preprocessing experience representing normalized processing for the target content before reviewed; and
determining an integration result of the preprocessing experience and the review experience as the circulation information of the target content among the plurality of processing nodes.

19. The non-transitory computer-readable storage medium according to claim 15, wherein the detection data comprises at least: number of invocations for the processing node, number of generations of processing information representing the success of processing by the processing node, number of generations of processing information representing the failure of processing by the processing node, number of processing time of the processing node for the target content within a preset time range, number of anomalies of an account of the target content, and quantity of abnormal fields contained in the target content.

20. The non-transitory computer-readable storage medium according to claim 15, wherein the collecting data for the detection event to obtain detection data corresponding to the detection event comprises:
collecting, when a detection time point is reached, data of the detection event within the preset time range to obtain the detection data of the detection event.
